(19) United States
(12) Patent Application Publication
(10) Pub. No.: US 2010/0245688 A1
(43) Pub. Date: Sep. 30, 2010

(54) PROJECTOR

(75) Inventors: Hiroaki YANAI, Shiojiri-shi (JP); Tomohiro TAKAGI, Matsumoto-shi (JP); Shingo TADA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/729,875

(22) Filed: Mar. 23, 2010

(30) Foreign Application Priority Data
Mar. 25, 2009 (JP) 2009-073838

(51) Int. Cl. G02F 1/1335

(52) U.S. Cl. 349/8

(57) ABSTRACT

A projector includes: an illumination device that emits an illumination light beam; a liquid crystal device that modulates the illumination light beam from the illumination device based on image information; a projection optical system that projects light modulated by the liquid crystal device; and at least one polarizing member that is disposed on a light exit side of the liquid crystal device and has in order a light-transmissive substrate, a pressure-sensitive adhesive layer, a KE polarizer, an adhesive layer, and a support layer, the polarizing member being positioned so that the adhesive layer is closer to a light exit side than is the KE polarizer.

### BACKGROUND

1. Technical Field

The present invention relates to a projector having a liquid crystal device, the projector including a polarizing member. More specifically, the invention relates to a projector including a polarizing member having in order a support layer, an adhesive layer, a KE polarizer, a pressure-sensitive adhesive layer, and a light-transmissive substrate, the adhesive layer being less susceptible to photodegradation (yellowing).

2. Related Art

In a projector having a liquid crystal device that serves as an electrooptical modulator, a polarizing member that serves as a polarizer is disposed on the light incidence side of the liquid crystal device (hereinafter sometimes referred to as “incidence-side polarizing member”) and a polarizing member that serves as an analyzer is disposed on the light exit side of the liquid crystal device (hereinafter sometimes referred to as “exit-side polarizing member”).

Common examples of such polarizing members for use in a projector are those having a polarizing layer formed by dyeing a polyvinyl alcohol film (PVA film) with iodine or a dichromatic dye, and uniaxially stretching the dyed film to unidirectionally orient molecules of the dye.

Meanwhile, there are known polarizing members that include a KE polarizer obtained by uniaxially stretching a polyvinyl alcohol film (PVA film) followed by dehydration to impart polarization characteristics thereto, a triacetyl cellulose film or like light-transmissive synthetic resin film attached to one side of the KE polarizer using an adhesive, and a light-transmissive substrate attached to the other side of the KE polarizer using a pressure-sensitive adhesive (hereinafter, such a polarizing member having a KE polarizer is sometimes referred to as “KE polarizing member”).

In connection with the invention, JP-A-2007-316565 discloses a projector including an illumination device, an liquid crystal device, a projection optical system, an incidence-side polarizing plate that is disposed on the light incidence side of the liquid crystal device and has a polarizing layer and a support layer, and an exit-side polarizing plate that is disposed on the light exit side of the liquid crystal device and has a polarizing layer and a support layer, in which the support layer is only on the opposite side from the liquid crystal device in the polarizing layer. Use of such a projector prevents the projected image quality from being reduced due to an increase in the temperature of the polarizing plates.

Further, JP-A-10-133196 proposes a liquid crystal projector that uses two polarizing plates having different polarization degrees so that the amount of light absorption is moderately shared by the polarizing plates, whereby the durability of the polarizing plates can be improved, enabling higher output.

### SUMMARY

The present inventors contemplated use of such a KE polarizing member as a polarizing member for use in a projector having a liquid crystal device that serves as an electrooptical modulator.

A KE polarizing member has a KE polarizer, and thus maintains its absorption characteristics even when used for a long period of time, exhibiting stable polarization characteristics over a long period of time. In addition, because a light-transmissive synthetic resin film (support layer), which is a cause of unevenness due to thermal stress, is only on one side, high-quality images can be achieved by allowing light to enter the polarizing film from the opposite side from the light-transmissive synthetic resin film. Further, because the light-transmissive synthetic resin film is only on one side, this will be effective in reducing the component cost.

However, use of such a KE polarizing member causes the following new problems. That is, the KE polarizing member includes a KE polarizer and a triacetyl cellulose film or like light-transmissive synthetic resin film that serves as a support layer, which are bonded together through an adhesive layer. When used for a long period of time, the adhesive layer may undergo photodegradation (yellowing), resulting in reduced optical reliability. Particularly in recent years, projectors are required to have smaller size and higher performance. Thus, the present situation is that polarizing members are often exposed to high light intensity and high temperature, where the adhesive layer is susceptible to degradation.

An advantage of some aspects of the invention is to provide a projector having a polarizing member that includes a support layer, an adhesive layer, and a KE polarizer, the polarizing member being disposed in such a manner that photodegradation (yellowing) is unlikely to occur.

The inventors conducted extensive research on polarizing members for use in a projector having a liquid crystal device that serves as an electrooptical modulator. As a result, they found that in the case where a KE polarizing member is placed inside a projector, when the KE polarizing member is positioned so that an adhesive layer is on the light incidence side and a KE polarizer is on the light exit side, the adhesive layer is less susceptible to photodegradation (yellowing), whereby the polarizing member exhibits stable optical characteristics over a long period of time. The invention was thus accomplished.

Specifically, according to some aspects of the invention, the projectors described in the following are provided.

According to of some aspects of the invention provides a projector having an illumination device that emits an illumination light beam, a liquid crystal device that modulates the illumination light beam from the illumination device based on image information, a projection optical system that projects light modulated by the liquid crystal device, and at least one polarizing member that is disposed on a light exit side of the liquid crystal device and has in order a light-transmissive substrate, a pressure-sensitive adhesive layer, a KE polarizer, an adhesive layer, and a support layer. The polarizing member is positioned so that the adhesive layer is closer to a light exit side than is the KE polarizer.

In the projector, the adhesive layer of the polarizing member is behind the KE polarizer that absorbs polarized light. As a result, the amount of light applied to the adhesive layer is relatively smaller than in the case where the adhesive layer is in the front, whereby photodegradation (yellowing) is reduced, and stable optical characteristics can be exhibited over a long period of time.

The projector according to the above-mentioned aspect, wherein the polarizing member includes a polarizing member provided with a KE polarizer (I) having a cross transmittance (Tc) of 0% to 0.1% and a polarizing member provided with a KE polarizer (II) having a cross transmittance (Tc) of 45 to 55%. The polarizing member is positioned so that the polarizing member provided with a KE polarizer (II) is closer to the liquid crystal device and the polarizing member provided with a KE polarizer (I) is closer to the projection optical system.

The projector further allows the amount of light absorption to be moderately shared by the polarizers, whereby the durability of the polarizing members can be improved, providing a liquid crystal projector capable of higher output.

The projector according to the above-mentioned aspect, wherein the polarizing member includes a polarizing member provided with a KE polarizer (I) having a cross transmittance (Tc) of 0% to 0.1%, a polarizing member provided with a KE polarizer (II) having a cross transmittance (Tc) of 45 to 55%, and a polarizing member provided with a KE polarizer (III) having a cross transmittance (Tc) of 61 to 71%. The polarizing member is positioned so that the polarizing members are in the following order, starting from the polarizing member closest to the liquid crystal device: the polarizing member provided with a KE polarizer (III), the polarizing member provided with a KE polarizer (II), and the polarizing member provided with a KE polarizer (I).

The projector further allows the amount of light absorption to be moderately shared by the polarizers, whereby the durability of the polarizing members can be improved, providing a liquid crystal projector capable of higher output.

The projector according to the above-mentioned aspect, wherein the adhesive layer is made of a UV-curable adhesive.

The projector as discussed above offers advantages in that even when a projector includes a KE polarizing member using a UV-curable adhesive that has excellent production efficiency but is susceptible to photodegradation (yellowing), the adhesive layer of the KE polarizer is less susceptible to photodegradation (yellowing), and as a result, stable optical characteristics can be exhibited over a long period of time.

### BRIEF DESCRIPTION OF THE DRAWINGS

The invention will be described with reference to the accompanying drawings, wherein like numbers reference like elements.

FIG. 1 shows a sectional view of the layer structure of a polarizing member for use in the invention.

FIGS. 2A to 2C each show a sectional view of the layer structure of a polarizing member for use in the invention.

FIG. 3 shows a schematic diagram of a projector according to an aspect of the invention.

FIG. 4 shows a sectional view of the layer structure of a liquid crystal valve included in a projector according to an aspect of the invention.

FIG. 5 shows a sectional view of the layer structure of a liquid crystal valve included in a projector according to an aspect of the invention.

### DESCRIPTION OF EXEMPLARY EMBODIMENTS

A projector according to an aspect of the invention is a projector having an illumination device that emits an illumination light beam, a liquid crystal device that modulates the illumination light beam from the illumination device based on image information, and a projecting optical system that projects the light modulated by the liquid crystal device. The projector includes at least one polarizing member that is disposed on the light exit side of the liquid crystal device and has in order a light-transmissive substrate, a pressure-sensitive adhesive layer, a KE polarizer, an adhesive layer, and a support layer. The polarizing member is positioned so that the adhesive layer is closer to the light exit side than is the KE polarizer.

The following explains projectors according to some aspects of the invention with reference to the illustrated embodiments.

### Embodiment 1

A projector according to Embodiment 1 has a polarizing member that is disposed on the light exit side of a liquid crystal device. The polarizing member has in order light-transmissive substrate, a pressure-sensitive adhesive layer, a KE polarizer, an adhesive layer, and a support layer, and is positioned so that the adhesive layer is closer to the light exit side than is the KE polarizer.

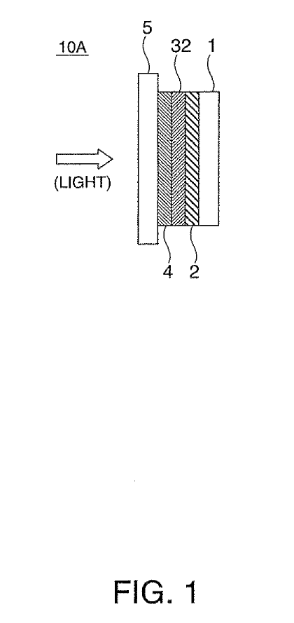

FIG. 1 shows a sectional view of the layer structure of a polarizing member 10A of the projector according to Embodiment 1.

In FIG. 1, 1 is a support layer, 2 is an adhesive layer, 3 is a KE polarizer, 4 is a pressure-sensitive adhesive layer, and 5 is a light-transmissive substrate.

Hereinafter, for convenience, all support layers are indicated by 1, all adhesive layers are indicated by 2, all pressure-sensitive adhesive layers are indicated by 4, and all light-transmissive substrates are indicated by 5.

### Support Layer

The support layer 1 of the polarizing member 10A shown in FIG. 1 is not limited insofar as it has excellent light transmittance in the visible region.

Examples of materials for the support layer 1 include light-transmissive, synthetic resins such as acetyl cellulose resins, acrylic resins, polycarbonate resins, polyethylene terephthalate resins, polyimide resins, polyethylene naphthalates, epoxy resins, cyclic olefin resins, cyclic olefin-ethylene copolymer resins, polyvinyl butyral resins, polyether sulfone resins, polyvinyl chlorides, and polystyrenes.

In addition, a mixture of two or more kinds of resins may also be used, examples thereof including polyethylene/polyphenylene ether, polyvinyl chloride/styrene-acrylonitrile copolymer, and polyvinyl chloride/polymethyl methacrylate.

Among these, acetyl cellulose resins are preferable, and triacetyl cellulose is particularly preferable.

The thickness of the support layer 1 is usually to 300 μm, preferably 50 to 200 μm, and more preferably 60 to 150 μm.

In addition, on the surface of the support layer where the below-mentioned adhesive layer 2 is not provided, an antireflection layer (not illustrated) may be formed.

The antireflection layer may be formed by a dry process or a wet process. A dry process is a method in which a layer is formed by vacuum deposition, sputtering, ion plating, or the like. A wet process is a method in which a coating liquid for forming a layer is applied by bar coating, knife coating, roll coating, blade coating, die coating, gravure coating, or the like, followed by heat curing, thereby forming a layer.

### Adhesive Layer

In the polarizing member 10A shown in FIG. 1, the support layer 1 and the KE polarizer 3 are bonded together through the adhesive layer 2.

The adhesive used for forming the adhesive layer 2 may be a heat-curable adhesive or a UV-curable adhesive. Examples of heat-curable adhesives include polyolefin adhesives such as copolymers of ethylene and acid anhydrides, epoxy resin adhesives, urethane resin adhesives, and phenol resin adhesives. Examples of UV-curable adhesives include acrylic adhesives, enethiol adhesives, and epoxy adhesives. Among these, UV-curable adhesives are preferable in terms of production efficiency.

The arrangement of the polarizing member 10A as shown in FIG. 1 is resistant to photodegradation even when using a UV-curable adhesive prone to photodegradation.

Further, the adhesive used may contain a silane coupling agent. The silane coupling agent used is not limited insofar as it contributes to the improvement of adhesion between the support layer 1 and the KE polarizer 3.

Examples of such silane coupling agents include 2-(3,4-epoxycyclohexyl)ethyltrimethoxysilane, 3-glycidoxypropyltrimetoxysilane, 3-glycidoxypropylmethyldiethoxysilane, 3-glycidoxypropyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxyprophyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropylmethyldimethoxysilane, and 3-mercaptopropyltrimethoxysilane.

The arrangement of the polarizing member 10A as shown in FIG. 1 is resistant to photodegradation even when using an adhesive containing a silane coupling agent, which is more prone to photodegradation.

When the adhesive used contains a silane coupling agent, the content is preferably 0.1 wt % to 10 wt % relative to the adhesive, and more preferably 0.3 wt % to 7 wt %.

### KE Polarizer

The KE polarizer 3 of the polarizing member 10A shown in FIG. 1 is usually a KE polarizer having a cross transmittances (Tc) of 0% to 0.1%.

The cross transmittance (Tc) can be determined as follows. When linearly polarized light (Pa), which is obtained by allowing light from the light source to pass through a polarizer, enters at a right angle to the transmission axis of a subject of measurement, the amount of light (Pt) that has passed through the subject of measurement is measured, whereby the cross transmittance (Tc) can thus be determined by the following equation.

(Tc)=(Pt)/(Pa)×100(%)

An example of the KE polarizer is a sheet or film of oriented poly(vinyl alcohol)-type (PVA-type) material having an oriented suspension of a dehydration product of polyvinyl alcohol (PVA), polyvinylene, in a matrix of PVA, for example.

Typically, KE polarizers of this kind can be formed by unidirectionally stretching a polymer film to align the PVA matrix and heating the PVA-type polymer film in the presence of a dehydration catalyst, such as hydrochloric acid, to produce conjugated polyvinylene blocks.

Further, as described in U.S. Pat. No. 5,666,223, it is also possible to use a polymer film that has been converted and then subjected to a boration treatment.

The thickness of the KE polarizer is usually 10 to 50 μm, and preferably 20 to 40 μm.

The KE polarizer can be produced as follows.

First, a polyvinyl alcohol film is uniaxially stretched and dehydrated to achieve polarization characteristics.

A polyvinyl alcohol film is a film made of resin containing a vinyl alcohol polymer.

Specific examples of vinyl alcohol polymers include linear 1,3-polyhydroxylated polymers and copolymers that can be dehydrated into linear, conjugated vinyl polymers, as well as derivatives thereof.

Useful vinyl alcohol polymers include polymers and copolymers of units having the following formula:

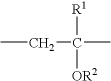

wherein R¹ is a hydrogen atom, a C₁₋₈ alkyl group, or an aryl group, and R² is a hydrogen atom or a hydrolyzable functional group such as a C₁₋₈ acyl group, the R¹ and R² preferably being hydrogen atoms.

Examples of comonomers that can be polymerized with vinyl alcohol monomers to produce vinyl alcohol copolymers include ethylene, propylene, butylene, and like olefins; acrylates, methyl methacrylate, and like (meth)acrylates; vinyl acetate and like vinyl esters; and styrenes, α-methyl styrene, and like aromatic vinyl compounds.

When the vinyl alcohol polymer is a vinyl alcohol copolymer, the amount of the comonomer used is less than 30 mol %, preferably less than 10 mol %, relative to the whole monomer. When the amount of the comonomer is large, this may retard the formation of conjugated alcohol copolymer, the amount of the comonomer used is less than 30 mol %, preferably less than 10 mol %, relative to the whole monomer. When the amount of the comonomer is large, this may retard the formation of conjugated vinylene blocks (poly(acetylene)blocks), adversely affecting the performance of the polarizer.

Among these, homopolymers of vinyl alcohol and vinyl alcohol copolymers are preferable as vinyl alcohol polymers. Vinyl alcohol homopolymers are more preferable.

Further, polyvinyl acetal, polyvinyl ketal, and polyvinyl ester may also be used as vinyl alcohol polymers.

Melt-processable polyvinyl alcohol may also be used in this invention.

The melt-processable vinyl alcohol polymers are plasticized to enhance their thermal stability and allow them to be extruded or melt-processed.

The plasticizer can be added externally or may be part of the vinyl alcohol polymer chain. In other words, the plasticizer is polymerized or grafted onto the vinyl alcohol polymer backbone.

Examples of vinyl alcohol polymers that can be externally plasticized include commercially available products such as “Mowiol” 26-88 and “Mowiol” 23-88 vinyl alcohol polymer resins available from Clariant Corp., Charlotte, N.C.

Plasticizers useful in externally plasticizing vinyl alcohol polymers include high boiling, water-soluble organic compounds having hydroxyl groups. Examples of such compounds include water, glycerol, polyethylene glycols such as triethylene glycol and diethylene glycol, trimethylol propane, and combinations thereof.

The amount of plasticizer to be added varies with the molecular weight of vinyl alcohol polymer.

In general, a plasticizer is added in an amount of about 5 wt % to about 30 wt %, preferably about 7 wt % to about 25 wt %, relative to vinyl alcohol.

Materials available from Celanese under the trademark Vinex are thermoplastic, water-soluble polyvinyl alcohol resins of a certain kind. For example, the “Vinex” 2000 series including “Vinex” 2034 and “Vinex” 2025 represents internally plasticized, cold- and hot-water soluble polyvinyl alcohol copolymer resins. Such internally plasticized vinyl alcohol copolymers are described in U.S. Pat. No. 4,948,857. Such copolymers have the following general formula:

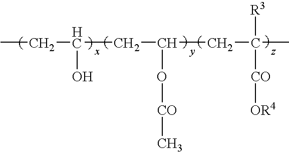

wherein R³ is a hydrogen group or a methyl group, R⁴ is a C₆₋₁₈ acyl group, y is 0 to 30 mol %, z is 0.5 to 8 mol %; and x is 70 to 99.5 mol %.

These copolymers retain the strength properties of vinyl alcohol polymers and also exhibit increased flexibility. The acrylate monomer represented by the above formula imparts its internal plasticization effect to the copolymer.

First, a polyvinyl alcohol film (hereinafter sometimes referred to simply as “film”) can be uniaxially stretched using a suitable stretching device or similar mechanism or system. The polyvinyl alcohol film may be stretched about 3.5 times to about 7.0 times the original length of the film or greater.

Stretching may be performed at various stages throughout the film production process. Stretching that occurs before conversion is herein referred to as a first and x is 70 to 99.5 mol %.

These copolymers retain the strength properties of vinyl alcohol polymers and also exhibit increased flexibility. The acrylate monomer represented by the above formula imparts its internal plasticization effect to the copolymer.

First, a polyvinyl alcohol film (hereinafter sometimes referred to simply as “film”) can be uniaxially stretched using a suitable stretching device or similar mechanism or system. The polyvinyl alcohol film may be stretched about 3.5 times to about 7.0 times the original length of the film or greater.

Stretching may be performed at various stages throughout the film production process. Stretching that occurs before conversion is herein referred to as a first stretching step, and may occur before the film is exposed to a dehydration catalyst, while the film is in the dehydration catalyst, and/or after the film is removed from the dehydration catalyst. Stretching that occurs simultaneously with conversion is referred to as a second stretching step. Stretching that occurs after conversion, for example during or after a boration step, is referred to as a third stretching step.

The first stretching step may be performed before, during, or after the film is exposed to a dehydration catalyst.

First, the film is exposed to a dehydration catalyst, such as an aqueous acid solution, and is subjected to the first stretching.

The film is then converted to form dichroic chromophore, and simultaneously stretched in the second stretching step.

Conversion herein refers to the formation of conjugated polyvinylene blocks from polyvinyl alcohol. By orienting the PVA matrix unidirectionally, the transition moments of the conjugated polyvinylene blocks are also oriented, and the material becomes visibly dichroic. The conjugated polyvinylene blocks may be referred to as dichroic chromophores.

In the conversion step, a portion of the vinyl alcohol polymer in the film is converted to polarizing molecules of block copolymers of poly(vinylene-co-vinyl alcohol).

One method for converting vinyl alcohol is to first expose the film to a dehydration catalyst and then heat the exposed film, thereby causing dehydration to take place.

The film may be exposed to a dehydration catalyst in different ways. For example, the film is dipped or immersed in an aqueous dehydration catalyst with sufficient residence time to allow the catalyst to diffuse into the film.

The film may be immersed in deionized water for about 1 second to about 5 minutes, and then immersed in an aqueous hydrochloric acid solution for about one second to several minutes.

The concentration of the aqueous hydrochloric acid solution is correlated with the (Tc) of the resulting KE polarizer, and the higher the concentration of the aqueous hydrochloric acid solution, the lower the (Tc) of the KE polarizer. The concentration is preferably about 0.001 Normal to about 0.1 Normal.

As another example, a method that exposes the film to acidic fumes containing a dehydration catalyst can be mentioned. Dipping the film potentially allows higher processing speeds to be attained than by acid fuming.

The dehydration catalyst may be any acid or other agent that is capable of removing hydrogen and oxygen atoms from the hydroxylated moieties of the linear polymer in the presence of heat or under other appropriate processing conditions, thereby leaving conjugated vinylene units.

The acid used may be hydrochloric acid, hydrobromic acid, hydroiodic acid, phosphoric acid, or sulfuric acid. These acids may be diluted with methanol.

The desired degree of dehydration varies depending on the desired contrast and the film thickness, and is typically in a range of 0.1 to 10%. Preferably, 1 to 5% of available hydroxyl groups are converted to vinylene groups (i.e., —CH₂—CHOH—→—CH═CH—).

After exposing the film to the dehydration catalyst, the PVA-type film and the adsorbed catalyst may be heated, whereby the oriented film is converted into the desired dehydration product, i.e., polyvinylene. The film may be heated by conduction heating, convection heating, radiation heating, or a combination thereof.

For example, the film and the catalyst may be passed through a heating oven at a temperature of about 88° C. to about 205° C. for about a few seconds to about 10 minutes. In a different method, the film and the catalyst may be exposed to microwave radiation heating or to laser heating.

Another method for converting the film is to expose the film and the catalyst to radiant infrared heating, which is generated using one or more infrared heating lamps, for example, for about 1 second to about seconds. Infrared heating allows higher processing speeds to be attained than by hot air impingement.

The polymer film may be subjected to the second stretching step during the conversion process. In other words, the film may be subjected to the second stretching during the conversion process. The second stretching step may result in an increase in the film length by up to about 2.5 times the intermediate length of the film obtained after the first stretching step.

Like the first stretching step, the second stretching step is performed at a temperature higher than the glass transition temperature of the polymer material, and may be effected by the provision of heat-generating elements, fast rollers, and slow rollers.

After the conversion, the film may be subjected to a boration step. For example, the converted film is exposed to an aqueous boration solution to borate the oriented film. The boration step effects relaxation and cross-linking.

The third stretching step may be performed before, during, or after the film is borated. For example, the film may be submerged in an aqueous boration solution, allowing the film to soften and/or swell. This often results in relaxation or shrinkage of the film. The film is subsequently removed and dried.

The boration step may be performed using one or more baths. For example, in a two-bath boration treatment, the first bath may contain water, and the second bath may contain a boric ion contributing species. The order of the baths may be reversed or both baths may contain varying concentrations and/or mixtures of boric ion contributing species. Stretching and/or relaxation of the film may be conducted in any one or more of these baths.

A boration solution generally has boric acid. In addition, the boration solution may further contain sodium hydroxide or potassium hydroxide, or may contain a substance from the class consisting of sodium borate and potassium borate, preferably borax.

The concentrations of boric acid and borax or a like borate in one or more solutions to which the film is exposed may vary. Preferably, the boric acid is present at a higher concentration than borax or a like borate, and the solution contains about 5 wt % to about 20 wt % boric acid and 0 wt % to about 7 wt % borax. A preferred concentration is 6 wt % to 16 wt % boric acid and 0 wt % to 3 wt % borax.

The film may be immersed in one or more boration solutions for a period of about 1 minute to about 30 minutes preferably at a temperature maintained at about 50° C. or higher. A preferred boration temperature is about 70° C. to about 110° C.

After the exposure to the boron-containing solution, the resulting film may be rinsed and dried. The film may be rinsed by any suitable method, such as passing the sheet through a deionized water bath or spraying deionized water on the film.

The film may be dried by heating the film by convection or radiation heating or by passing the film through a convection oven, for example.

Processing agents may be added to the boration bath to aid in the process. For example, a surfactant such as Triton X-100 commercially available from Union Carbide (Danbury, Conn.) may be added thereto.

If not left under tension, the film shrinks during the boration step. Allowing the film to shrink permits the film to absorb a larger amount of the boron-containing solution, and thus leads to a higher degree of cross-linking, with a concomitant increased environmental stability.

The process of wet-stretching, conversion, and boration can be applied as a continuous, integrated process. Such a continuous process is simpler than the multi-step processes that have been used for intrinsic polarizers in the past, and leads to higher film yield and reduced polarizer cost.

The thus-obtained polarizing film has a composite of a molecularly oriented film of a PVA/polyvinylene block copolymer material having polyvinylene blocks formed by molecular dehydration of a film of polyvinyl alcohol. The molecularly oriented film of a polyvinyl alcohol/polyvinylene block copolymer material has a uniform distribution of polarizing molecules of a polyvinyl alcohol/polyvinylene block copolymer material varying in the number (n) of the conjugated repeating vinylene units of the polyvinylene block of the copolymer. The value of n is 2 to about 25. The degree of orientation of the polarizing molecules increases throughout the range with an increase in the value of n.

The degree of orientation of the molecules related to the concentration distribution of each polyvinylene block is sufficient to provide the polymer sheet with a photopic dichroic ratio (RD) of at least 10.

Ignoring surface reflections, the photopic dichroic ratio D is defined by D=Az/Ay. Here, Az and Ay are determined as follows. A sample polarizer is illuminated with a white-light sample beam of a dual beam spectrophotometer. The sample beam is pre-polarized using a high-efficiency Glan polarizer. The amount of light transmitted through the sample polarizer at a particular wavelength is compared with the amount of light at the same wavelength in the reference beam, and the absolute absorbance of the sample polarizer is calculated as a function of wavelength from the ratio between a transmitted sample beam and a transmitted reference beam. The absorbance is calculated over a range of 380 nm to 780 nm. The absorbance spectra are obtained both for light polarized parallel to the transmission axis of the sample polarizer and for light polarized perpendicular to the transmission axis of the sample polarizer. The parallel and perpendicular absorbance spectra are then spectrally corrected for the spectrum of a particular light source and the response of the human eye (photopic correction). The integrated area under the corrected parallel absorbance spectrum corresponds to the amount Ay of spectrally corrected, parallel polarized light absorbed in a single pass through the sample polarizer. The integrated area under the corrected perpendicular absorbance spectrum corresponds to the amount Az of spectrally corrected, perpendicular polarized light absorbed in a single pass through the sample polarizer.

### Pressure-Sensitive Adhesive Layer

In the polarizing member 10A shown in FIG. 1, a surface of the KE polarizer 3 where the adhesive layer 2 is not provided is bonded together with the below-mentioned light-transmissive substrate 5 through the pressure-sensitive adhesive layer 4.

The pressure-sensitive adhesive layer 4 can be formed by applying a pressure-sensitive adhesive composition on the surface of the KE polarizer 3 followed by drying, for example.

The pressure-sensitive adhesive composition used is not limited, and may be a known pressure-sensitive adhesive composition containing an acrylic polymer and a cross-linking agent. It may also contain PSA (Pressure Sensitive Adhesive) having excellent adhesive strength, heat resistance, and moisture resistance.

Examples of acrylic polymers include those obtained by polymerizing one or more kinds of monomers selected from n-butyl acrylate, t-butyl acrylate, 2-ethylhexyl acrylate, n-octyl acrylate, isononyl acrylate, acrylic acid, methyl methacrylate, and the like.

Examples of cross-linking agents include monomers containing carboxyl groups, such as acrylic acid, methacrylic acid, maleic acid, and itaconic acid, which may have two functional groups; monomers containing hydroxyl groups, which may have two functional groups; acrylamide; methacrylamide; and glycidyl amide.

### Light-Transmissive Substrate

The polarizing member 10A shown in FIG. 1 has the light-transmissive substrate 5 on the surface of the KE polarizer 3 where the adhesive layer 2 is not provided, with the pressure-sensitive adhesive layer 4 in between.

The light-transmissive substrate 5 used is not limited and may be known. Examples thereof include substrates made of quartz glass, hard glass, crystallized glass, a cubic sintered body, sapphire, quartz, clear glass, heat-resistant glass, YAG polycrystal, aluminum oxynitride, and the like.

The polarizing member 10A shown in FIG. 1 is characterized in that inside a projector, the adhesive layer is closer to a light exit side than is the KE polarizer.

With such an arrangement, the adhesive layer 2 of the polarizing member 10A is less susceptible to photodegradation (yellowing) even when used over a long period of time. As a result, stable optical characteristics can be exhibited over a long period of time.

A consideration of the arrangement inside the projector will show that light passes through the entrance plane, some of which is absorbed by the polarizer, and the light then passes through the exit plane, and that the amount of light is thus obviously different between the entrance plane and the exit plane. Accordingly, when, as in the KE polarizing member, there is a difference in optical durability between the materials on opposite sides of the KE polarizer used, it is preferable that the side having a material with lower optical durability is on the exit side.

### Embodiment 2

A projector according to Embodiment 2 is characterized in that a KE polarizer having a relatively large cross transmittance (Tc) is on the light incidence side (liquid crystal device), while a KE polarizer having a relatively small cross transmittance (Tc) is on the light exit side (projection optical system).

The projector according to Embodiment 2 may be a projector having a polarizing member that includes two KE polarizing elements: a KE polarizer (I) having a cross transmittance (Tc) of 0% to 0.1% and a KE polarizer (II) having a cross transmittance (Tc) of 45 to 55%. The projector according to Embodiment 2 may also be a projector having a polarizing member that includes three KE polarizers: a KE polarizer (I) having a cross transmittance (Tc) of 0% to 0.1%, a KE polarizer (II) having a cross transmittance (Tc) of 45 to 55%, and a KE polarizer (III) having a cross transmittance (Tc) of 61 to 71%.

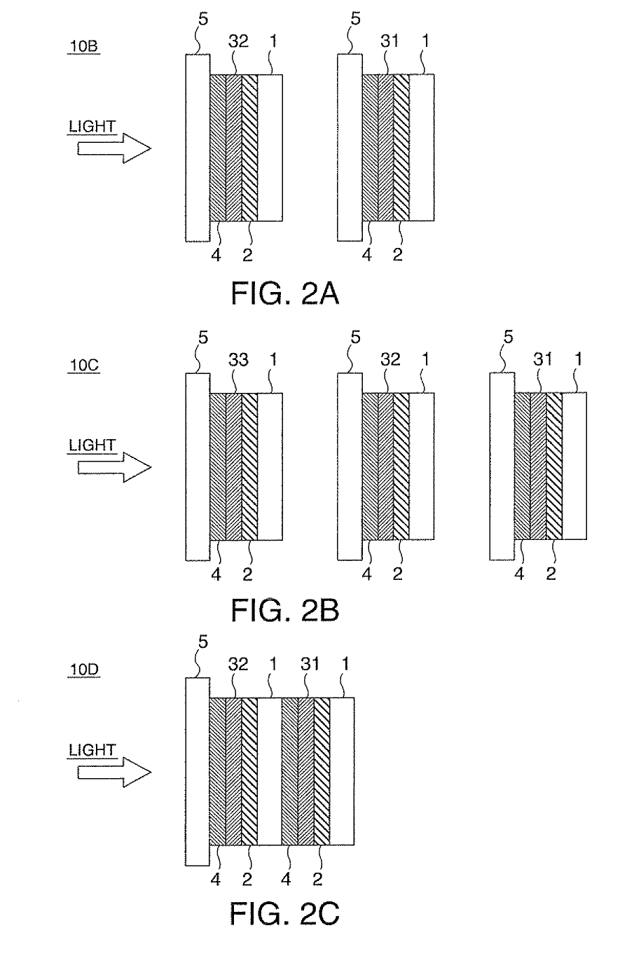

FIGS. 2A and 2B show sectional views of polarizing members 10B and 10C, respectively, of the projector according to Embodiment 2.

In FIGS. 2A to 2C, 1 is a support layer, 2 is an adhesive layer, 31 is a KE polarizer (I), 32 is a KE polarizer (II), 33 is a KE polarizer (III), 4 is a pressure-sensitive adhesive layer, and 5 is a light-transmissive substrate.

The polarizing member 10B shown in a FIG. 2A is characterized in that the KE polarizer (II) 32 is on the light-entrance-plane side and the KE polarizer (I) 31 is on the light-exit-plane side. The polarizing member 10C shown in FIG. 2B is characterized in that the KE polarizers are in the following order, starting from the polarizer closest to the light entrance plane (liquid crystal device): the KB polarizer (III) 33, the KE polarizer (II) 32, and the KE polarizer (1) 31.

In the projector according to Embodiment 2, like Embodiment 1, a KE polarizer having a relatively large cross transmittance (Tc) is on the light-entrance-plane side, while a KE polarizer having a relatively small cross transmittance (Tc) is on the light-exit-plane-side, so that the amount of light absorption is moderately shared by the polarizers, and the polarizing material thus has improved durability.

The support layer 1, the adhesive layer 2, the pressure-sensitive adhesive layer 4, and the light-transmissive substrate 5 may be the same as in the above-described polarizing member 10A.

As in the production of the KE polarizer 3 of the polarizing member 10A, the KE polarizers (II) 32 and (III) 33 can be formed by unidirectionally stretching a vinyl alcohol polymer film to align a PVA matrix, and heating the PVA-type polymer film in the presence of a dehydration catalyst such as hydrochloric acid or the like, thereby producing conjugated polyvinylene blocks, followed by a boration treatment.

However, in this case, the conditions for the dehydration of the PVA polymer film need to be suitably changed so that the resulting KE polarizer has a cross transmittance (Tc) of 45 to 55% or 61 to 71%.

Generally, in order to obtain a KE polarizer having a cross transmittance (Tc) of 45 to 55% or 61 to 71%, the degree of dehydration of the PVA polymer film should be lower than in the production of a KE polarizer having a cross transmittance (Tc) of 0% to 0.1%. The degree of dehydration of the PVA polymer film can be determined semiempirically by adjusting the concentration of the aqueous hydrochloric acid solution.

The KE polarizer (I) 31 can be obtained in the same manner as in the production of the KE polarizer 3 of the above-mentioned polarizing member 10A.

The KE polarizers (I) 31, (II) 32, and (III) 33 each usually have a thickness of 10 to 50 and preferably 20 to 40 μm.

In FIGS. 2A and 2B, the KE polarizers 31, 32, and 33 are separately provided on different light-transmissive substrates, and thus thermally insulated from one another, whereby heat generated by light absorption is effectively distributed.

However, the invention is not limited to such a separate arrangement, and the polarizers may also be laminated to one side of the single light-transmissive substrate 5 as shown in FIG. 2C. In this case, heat is transferred from one polarizer to another. Accordingly, although heat is not effectively distributed, this is effective in distributing the amount of light absorption and saving space. In addition, the polarizers may also be laminated to both sides of the light-transmissive substrate 5.

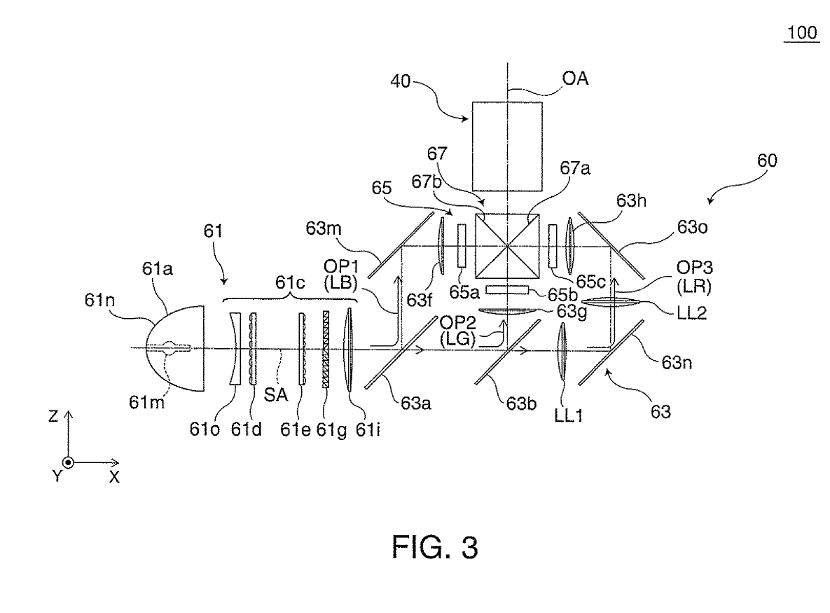

FIG. 3 shows a schematic diagram of a projector according to an aspect of the invention.

A projector 100 shown in FIG. 3 is a projection image display device.

This projector 100 includes an image-forming optical unit 60, an illumination device 61, and a projection optical system 40.

The image-forming optical unit 60 includes a color-splitting optical system 63 that splits illumination light emitted from the illumination device 61 into three colors, i.e., red, green, and blue; a light modulator 65 that is illuminated with the illumination light of each color emitted from the color-splitting optical system 63; and a cross dichroic prism 67 that synthesizes the modulated light of each color that has passed through the light modulator 65.

The light modulator 65 in the projector 100 shown in FIG. 3 serves as a liquid crystal device and a polarizing member.

The illumination device 61 includes a light source unit 61a that emits source light and a uniformizing optical system 61c that converts the source light emitted from the light source unit 61a into illumination light that is uniform and polarized in a predetermined direction. The light source unit 61a has a light source lamp 61m and a reflector 61n. The uniformizing optical system 61c includes a first lens array 61d for splitting the source light into partial beams, a second lens array 61e that adjusts the spread of the resulting partial beams, a polarization converter 61g that aligns the polarization directions of the partial beams, and an superimposing lens 61i that allows each partial beam to enter the intended illumination area in a superimposed manner.

The color-splitting optical system 63 includes a first dichroic mirror 63a, a second dichroic mirror 63b, and light-path-folding mirrors 63m, 63n, and 63o. The color-splitting optical system 63 divides the system optical axis SA into three light paths OP1 to OP3, thereby splitting the illumination light into three beams, i.e., blue light LB, green light LG, and red light LR. In addition, relay lenses LL1 and LL2 transmit an image, which is formed immediately in front of the first relay lens LL1 on the incidence-side, with little change to a field lens 63h on the exit side, thereby preventing the light utilization efficiency from being reduced due to diffusion of light, etc.

The light modulator 65 has three liquid crystal devices 65a, 65b, and 65c where the three colors of illumination light LB, LG, and LR enter, respectively. Depending on the drive signal, the light modulator 65 modulates, pixel by pixel, the intensity of LB, LG, and LR that have entered the liquid crystal devices 65a, 65b, and 65c through field lenses 63f, 63g, and 63h.

### Embodiment 3

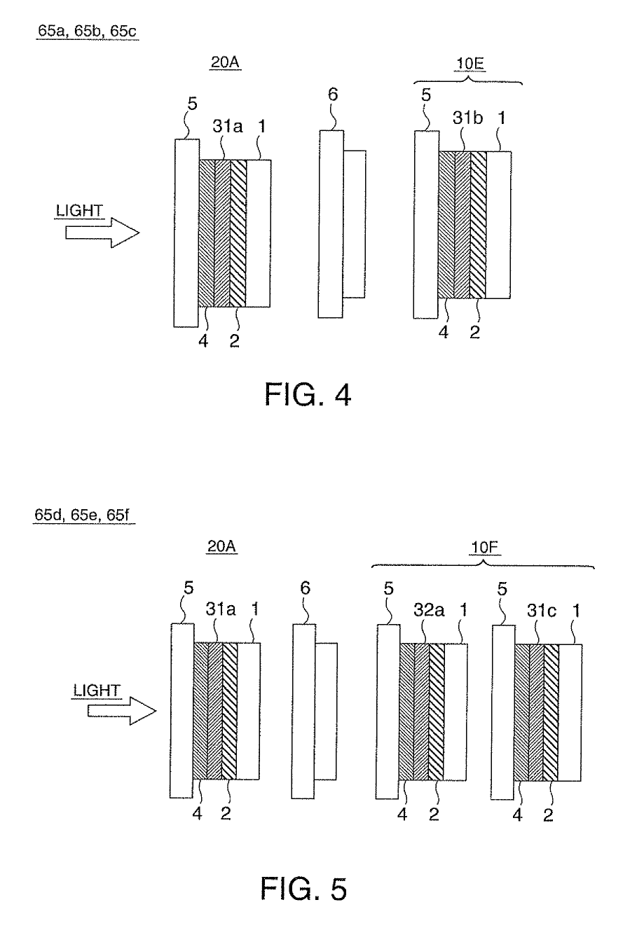

A projector according to Embodiment 3 is a projector having the liquid crystal devices 65a, 65b, and 65c of the projector 100 shown in FIG. 3. Each crystal device herein is an image-forming element having a liquid crystal panel sandwiched between a pair of polarizing plates as shown in FIG. 4.

In FIG. 4, 1 is a support layer, 2 is an adhesive layer, 31a and 31b are KE polarizers, 4 is a pressure-sensitive adhesive layer, 5 is a light-transmissive substrate, 6 is a liquid crystal panel, 20A is a polarizing member (incidence-side), and 10E is a polarizing member (exit side).

In each of the liquid crystal devices 65a, 65b, and 65c, the polarizing member 10E includes the support layer 1, the adhesive layer 2, the KE polarizer 31b, the pressure-sensitive adhesive layer 4, and the light-transmissive substrate 5, and is positioned so that the adhesive layer 2 is on the exit side and the KE polarizer 31b is on the incidence-side.

The cross dichroic prism 67 includes dichroic films 67a and 67b that intersect each other, and emits image light synthesized from the modulated light from the liquid crystal light valves 65a, 65b, and 65c.

As shown in FIG. 3, the projection optical system 40 projects the image light synthesized by the cross dichroic prism 67 on a screen at a magnification suitable for a color picture and with relatively low aberration.

Because the projector 100 shown in FIG. 3 has the polarizing member 10E, the adhesive layer 2 is less susceptible to photodegradation (yellowing) even when used over a long period of time. As a result, stable optical characteristics can be exhibited over a long period of time.

### Embodiment 4

A projector according to Embodiment 4 is the projector of Embodiment 3, but in which the polarizing member is a polarizing member 10F. The polarizing member 10F includes a KE polarizer (II) having a cross transmittance (Tc) of 45 to 55% and a KE polarizer (I) having a cross transmittance (Tc) of 0% to 0.1%, the KE polarizer (II) being on the light-entrance-plane side, the KE polarizer (I) being on the light-exit-plane side.

That is, the projector of Embodiment 4 has the same basic configuration as that of the projector of Embodiment 3, but includes liquid crystal devices 65d, 65e, and 65f shown in FIG. 5 in place of the liquid crystal devices 65a, 65b, and 65c of the projector of Embodiment 3.

In FIG. 5, 1 is a support layer, 2 is an adhesive layer, 31c is a KE polarizer (I), 32a is a KE polarizer (II), 4 is a pressure-sensitive adhesive layer, is a light-transmissive substrate, 6 is a liquid crystal panel, 20B is a polarizing member (incidence-side), and 10F is a polarizing member (exit side).

In each of the liquid crystal devices 65d, 65e, and 65f, the polarizing member 10F includes the support layer 1, the adhesive layer 2, the KE polarizer (I) 31c, the KE polarizer (II) 32a, the pressure-sensitive adhesive layer 4, and the light-transmissive substrate 5. The structure of the polarizing member 10F is the same as that of the polarizing member 103.

In addition to the advantages of the projector of Embodiment 3, the projector of Embodiment 4 allows the amount of light absorption to be moderately shared by the polarizers, whereby the durability of the polarizing members can be improved, enabling higher output.

### Modified Embodiments

The invention is not limited to the above embodiment, and, to the extent that the advantages of the invention can be provided, any modification, improvement, and the like are encompassed by the scope of the invention.

In the projector of Embodiment 4, the polarizing member on the exit side of a liquid crystal panel is the polarizing member 10F having the same structure as that of the polarizing member 10B. However, it may also be a polarizing member having the same structure as that of the polarizing member 10C or the polarizing member 10D.

In the projectors of Embodiments 3 and 4, the polarizing members on the exit sides of all the three liquid crystal devices are polarizing members having the same structures as those of the polarizing members 10B, 10C, and 10D. However, the invention is not limited thereto, and it is also possible that one or two of them are such polarizing members.

In the projector of Embodiment 4, all polarizers are disposed so that a KE polarizer is on the light-entrance-plane side and an adhesive layer is on the light-exit-plane side. However, the invention is not limited thereto. The life span is prolonged when at least one of the polarizers is disposed so that the adhesive layer thereof is on the exit side, as compared with the case where all adhesive layers are on the incidence-side.

The entire disclosure of Japanese Patent Application No. 2009-073838, filed Mar. 25, 2009 is expressly incorporated by reference herein.

What is claimed is:

1. A projector comprising:
an illumination device that emits an illumination light beam,
a liquid crystal device that modulates the illumination light beam from the illumination device based on image information;
a projection optical system that projects light modulated by the liquid crystal device; and
at least one polarizing member that is disposed on a light exit side of the liquid crystal device and has in order a light-transmissive substrate, a pressure-sensitive adhesive layer, a KE polarizer, an adhesive layer, and a support layer,
the polarizing member being positioned so that the adhesive layer is closer to a light exit side than is the KE polarizer.

2. The projector according to claim 1, wherein:
the polarizing member includes a polarizing member provided with a KE polarizer (I) having a cross transmittance (Tc) of 0% to 0.1% and a polarizing member provided with a KE polarizer (II) having a cross transmittance (Tc) of 45 to 55%, and
the polarizing member is positioned so that the polarizing member provided with a KE polarizer (II) is closer to the liquid crystal device and the polarizing member provided with a KE polarizer (I) is closer to the projection optical system.

3. The projector according to claim 1, wherein
the polarizing member includes a polarizing member provided with a KE polarizer (I) having a cross transmittance (Tc) of 0% to 0.1%, a polarizing member provided with a KE polarizer (II) having a cross transmittance (Tc) of 45 to 55%, and a polarizing member provided with a KE polarizer (III) having a cross transmittance (Tc) of 61 to 71%, and
the polarizing member is positioned so that the polarizing members are in the following order, starting from a polarizing member closest to the liquid crystal device: the polarizing member provided with a KE polarizer (III), the polarizing member provided with a KE polarizer (II), and the polarizing member provided with a KE polarizer (I).

4. The projector according to claim 1, wherein the adhesive layer is made of a UV-curable adhesive.
